(19) United States
(12) Patent Application Publication
(10) Pub. No.: US 2026/0274702 A1
(43) Pub. Date: Sep. 17, 2026

(54) PURIFICATION METHOD FOR ANHYDROUS ALUMINUM CHLORIDE, AND GAS-PHASE NANO-ALUMINA PREPARATION DEVICE AND METHOD THEREFOR

(71) Applicants: GUANGZHOU HUIFU RESEARCH INSTITUTE CO., LTD., Guangdong (CN); HUBEI HUIFU NANOMATERIAL CO., LTD., Hubei (CN)

(72) Inventors: Zhengfa LI, Guangdong (CN); Xianjian DUAN, Guangdong (CN); Chunlei WU, Guangdong (CN); Yuelin WANG, Guangdong (CN); Chenggang WANG, Guangdong (CN)

(73) Assignees: GUANGZHOU HUIFU RESEARCH INSTITUTE CO., LTD., Guangdong (CN); HUBEI HUIFU NANOMATERIAL CO., LTD., Hubei (CN)

(21) Appl. No.: 19/671,127

(22) Filed: May 7, 2026

Related U.S. Application Data
(63) Continuation of application No. PCT/CN2023/137024, filed on Dec. 7, 2023.

(30) Foreign Application Priority Data
Nov. 9, 2023 (CN) 202311489380.5
Nov. 9, 2023 (CN) 202311489381.X

(51) Int. Cl. C01F 7/62; B03C 1/26; B04C 5/04; B04C 5/26; B04C 9/00; C01F 7/302

(52) U.S. Cl. CPC C01F 7/62; B03C 1/26; B04C 5/04; B04C 5/26; B04C 9/00; C01F 7/302

(57) ABSTRACT

A purification method for anhydrous aluminum chloride, and a gas-phase nano-alumina preparation device and a method therefor, belonging to the field of inorganic chemistry. Said purification method comprises the following steps: pulverizing an anhydrous aluminum chloride raw material into a powder, introducing the powder obtained by the pulverization and hot air into a sublimator, such that the powder is heated by the hot air so as to obtain an aluminum chloride sublimation gas, the temperature in the sublimator being 250-350° C., and the temperature of the hot air being 250-500° C.; and introducing the aluminum chloride sublimation gas into a cyclone separation mechanism to perform cyclone separation, so as to obtain an aluminum chloride gas, the temperature in the cyclone separation mechanism being 200-300° C.

### CROSS-REFERENCE TO RELATED APPLICATION

This application is a continuation of PCT application serial No. PCT/CN2023/137024, filed on Dec. 7, 2023, claims priority right to Chinese patent application No. 202311489381.X filed on Nov. 9, 2023, entitled “Purification method for anhydrous aluminum chloride”, and application No. 202311489380.5 filed on Nov. 9, 2023, entitled “Low iron content gas-phase nano-alumina preparation device and method”, the entirety of which is incorporated herein by reference.

### BACKGROUND

### Technical Field

The present disclosure relates to the field of inorganic chemistry technology, particularly relates to a purification method for anhydrous aluminum chloride, and a gas-phase nano-alumina preparation device and method therefor.

### Description of Related Art

Gas-phase nano-alumina, as a high-end nano-chemical raw material, has been widely used in industries such as powder coatings, lithium batteries, thermal insulation materials, and catalysis. Different application fields impose distinct technical requirements on gas-phase alumina. In the field of powder coatings, gas-phase alumina primarily serves to improve flowability of powder coatings, enhance electrostatic spraying performance, and optimize the external gloss performance of coatings. Therefore, there are high requirements for the particle fineness and uniformity of gas-phase alumina products; in the lithium battery industry, gas-phase alumina is mainly used as a modified positive electrode material and separator material for batteries. They have high requirements for the purity of the gas-phase alumina, especially for magnetic substances such as iron and nickel. The impurities in gas-phase alumina products are mainly introduced through the raw material anhydrous aluminum chloride. Currently, the primary raw materials used in the production of alumina by gas-phase method is industrial anhydrous aluminum chloride. Due to the limitations of domestic anhydrous aluminum chloride production processes, a small amount of hydrated aluminum chloride is produced during normal production due to the absorption of moisture from the air. This hydrated aluminum chloride will generate relatively large white particles when heated in the production system, which can easily form white spots in powder coating applications and thereby affect product quality. In addition, currently the production equipment for anhydrous aluminum chloride in China is mostly carbon steel equipment, which introduces iron substances into the raw material anhydrous aluminum chloride during production process, resulting in high iron content in anhydrous aluminum chloride products. According to the national standard “Industrial Anhydrous Aluminum Chloride” (GB/T3959-2008), the iron content (calculated as FeCl₃) of qualified, first-class, and superior industrial anhydrous aluminum chloride products is 0.08%, 0.05%, and 0.04%, respectively; in addition, it also contains some water-insoluble substances and other heavy metals. In the production of alumina by gas-phase method, the vaporization of raw materials and slag discharge during production can remove some impurities and meet most application requirements, but it is difficult to meet the increasingly high-performance requirements in the field of lithium batteries. Although high-purity aluminum chloride raw materials can be used to produce high-purity gas-phase alumina products, the significant increase in cost limits their application.

### SUMMARY

### Technical Problem

The purpose of the present disclosure is to provide a purification method for anhydrous aluminum chloride, which can purify and effectively remove impurities from industrial anhydrous aluminum chloride.

### Solution to Problem

To achieve the above objectives, the following technical solutions are included.

The first aspect of the present disclosure provides a purification method for anhydrous aluminum chloride, comprising the following steps:
pulverizing anhydrous aluminum chloride raw material into a powder, introducing the pulverized powder and hot air into a sublimator, such that the powder is heated by the hot air to obtain aluminum chloride sublimation gas, wherein the temperature inside the sublimator is maintained 250° C. to 350° C., and the temperature of the hot air is 250° C. to 500° C.;
introducing the aluminum chloride sublimation gas into a cyclone separation mechanism to perform cyclone separation, to obtain aluminum chloride gas, the temperature inside the cyclone separation mechanism is maintained 200° C. to 300° C.

In some embodiments, the temperature inside the sublimator is 280° C. to 300° C., and the temperature of the hot air is 280° C. to 350° C.

In some embodiments, the temperature inside the sublimator is 290° C. to 300° C., and the temperature of the hot air is 300° C. to 320° C.

In some embodiments, the cyclone separation mechanism comprises a first cyclone separator and a second cyclone separator connected in series. The aluminum chloride sublimation gas is introduced into the first cyclone separator for cyclone separation at 200° C. to 300° C., and the obtained gas-phase product is subsequently introduced into the second cyclone separator for cyclone separation at 200° C. to 280° C.

In some embodiments, the temperature inside the first cyclone separator is 250° C. to 300° C., and the temperature inside the second cyclone separator is 220° C. to 260° C.

In some embodiments, the temperature inside the first cyclone separator is 260° C. to 280° C., and the temperature inside the second cyclone separator is 240° C. to 250° C.

The second aspect of the present disclosure provides a gas-phase nano-alumina preparation device, comprising a conveying and processing mechanism, a sublimator, a gas heating mechanism, a cyclone separation mechanism, a reactor, a deacidification furnace, and a magnetic iron removal mechanism;
wherein, the conveying and processing mechanism is configured to pulverize and convey aluminum chloride raw material;
the sublimator has a feed inlet, a first air inlet, and a first air outlet; the conveying and processing mechanism is connected to the feed inlet of the sublimator and is configured to introduce the pulverized aluminum chloride powder into the sublimator, while the gas heating mechanism is connected to the first air inlet and is configured to introduce the heated gas into the sublimator to heat the aluminum chloride powder;
the cyclone separation mechanism has a second air inlet and a second air outlet, wherein the second air inlet is connected to the first air outlet, and the second air outlet is sequentially connected to the reactor, the deacidification furnace, and the magnetic iron removal mechanism.

In some embodiments, the magnetic iron removal mechanism comprises at least two sequentially connected magnetic attraction members, and the deacidified nano-alumina sequentially enters the magnetic attraction members, and a storage silo is set between two adjacent magnetic attraction members, wherein each magnetic attraction member features a tubular structure, and the inner walls of the tubular structures are coated with magnetic attraction layer.

In some embodiments, the magnetic attraction layer comprise multiple magnetic bodies, which are spaced apart along the circumferential and axial direction of the tubular structure, and adjacent magnetic bodies are staggered along the axial direction of the tubular structure.

In some embodiments, the magnetic iron removal mechanism comprises two magnetic attraction members, which cooperate to form a two-stage magnetic attraction structure.

In some embodiments, the cyclone separation mechanism comprises two cyclone separators connected in series, which are a first cyclone separator and a second cyclone separator, respectively, wherein both the first cyclone separator and the second cyclone separator include a separator body, which is provided with a second air inlet and a second air outlet. The second air inlet is provided on the side wall of the separator body along the transverse section direction of the separator body, and the second air inlet is located below the second air outlet.

In some embodiments, the outer wall of the separator body is provided with a first heating element, and the separator body is located on the outer side of the first heating element and is provided with a first thermal insulation layer.

In some embodiments, a guide element is provided inside the sublimator, and the guide element is arranged between the feed inlet and the first air inlet; and serves to guide the raw material powder entering from the feed inlet to the first air inlet, enabling the raw material powder to counter-flow against the hot air entering from the first air inlet.

In some embodiments, the outer wall of the sublimator is equipped with a second heating element. The sublimator is located on the outer side of the second heating element and is provided with a second thermal insulation layer.

In some embodiments, the first air outlet is located on one side of the sublimator, and an air outlet baffle is installed inside the sublimator; the air outlet baffle and the inner wall of the sublimator collectively form a guide chamber with one end open, and the first air outlet is connected to the guide chamber.

The third aspect of the present disclosure provides a preparation method for gas-phase nano-alumina, comprising the following steps:
pulverizing the aluminum chloride reaction raw material by a conveying and processing mechanism and then conveying into a sublimator; heating air in a gas heating mechanism, and then conveying the hot air into the sublimator; the hot air heats the aluminum chloride powder to produce aluminum chloride sublimation gas;
introducing the aluminum chloride sublimation gas into a cyclone separation mechanism for cyclone separation to obtain aluminum chloride gas;
introducing the obtained aluminum chloride gas into a reactor to react and generate nano-alumina;
introducing the nano-alumina into a deacidification furnace for deacidification;
introducing the deacidified nano-alumina into a magnetic iron removal mechanism for magnetic iron removal, then obtaining the nano-alumina.

### Effects of Invention

In the purification method of anhydrous aluminum chloride of the present disclosure, hot air at a specific temperature (250° C. to 500° C.) and industrial anhydrous aluminum chloride powder raw material are introduced into a sublimator at a specific temperature (250° C. to 350° C.). Under the action of the hot air, aluminum trichloride in the raw material undergoes gas-solid separation from ferric chloride. During this process, aluminum chloride vaporizes and sublimates. In the sublimation process, the hydrated aluminum chloride that absorbs water from the anhydrous aluminum chloride raw material dehydrates to form alumina particles. In the subsequent cyclone separation process, the specific temperature (200° C. to 300° C.) of the cyclone separation mechanism is controlled to ensure that solid particles undergo centrifugal motion and are captured in the cyclone. The sublimated aluminum chloride gas remains in a gaseous state and is separated from the solid particles, thereby achieving the purification of the anhydrous aluminum chloride raw material. This process effectively removes solid impurities such as hydrated aluminum chloride and ferric chloride absorbed by the anhydrous aluminum chloride raw material. As a result, the iron content in the obtained aluminum chloride product is reduced to below 72 ppm, and the water-insoluble content is reduced to 0.03%. When this aluminum chloride is applied in the preparation of alumina, the particulate matter in the finished alumina product can be reduced by 99% compared to the original level, and the iron content in the end product can be reduced from over 400 ppm to below 200 ppm.

In the present disclosure, the gas-phase nano-alumina preparation device is equipped with a conveying and processing mechanism, a sublimator, and a cyclone separation mechanism at the front end of the reactor, and a deacidification furnace and a magnetic iron removal mechanism at the rear end of the reactor. Before the aluminum chloride raw material is fed into the reactor for reaction, the iron removal and purification of the raw material aluminum chloride is achieved through the cooperation of the conveying and processing mechanism, sublimator, and cyclone separation mechanism. After the iron-purified aluminum chloride gas is introduced into the reactor for reaction, the nano-alumina product obtained is deacidified through the deacidification furnace, and then the magnetic iron-containing substances in the nano-alumina product are captured by adsorption using the magnetic iron removal mechanism, thus achieving iron removal from the nano-alumina product. This process can reduce the iron content in the nano-alumina product to below 150 ppm, effectively meeting the application requirements in the lithium battery field.

### BRIEF DESCRIPTION OF THE DRAWINGS

FIG. 1 is a schematic diagram of the overall structure of the gas-phase nano-alumina preparation device according to an embodiment of the present disclosure.

FIG. 2 is a schematic diagram of the partial structure of the gas-phase nano-alumina preparation device shown in FIG. 1.

FIG. 3 is a schematic diagram of the longitudinal section structure of the magnetic attraction component in FIG. 1.

### DESCRIPTION OF THE EMBODIMENTS

In order to facilitate the understanding of the present disclosure, a more comprehensive description about the present disclosure is given below. The present disclosure can be implemented in many different forms, and is not limited to the embodiments described herein. On the contrary, these embodiments are provided to make the understanding of the disclosure more thorough and comprehensive.

The experimental methods in the following embodiments that do not specify specific conditions are usually conducted under conventional conditions or as recommended by the manufacturer. All commonly used chemical reagents mentioned in the embodiments are commercially available products.

Unless otherwise defined, all technical and scientific terms used in the present disclosure have the same meaning as those commonly understood by those skilled in the art to which the present disclosure belongs. The terms used in the description of the present disclosure are for the purpose of describing specific embodiments only and are not intended to limit the present disclosure. The term “and/or” used in the present disclosure encompasses any and all combinations of one or more related listed items.

The embodiments of the present disclosure provide a purification method for anhydrous aluminum chloride, comprising the following steps:
pulverizing anhydrous aluminum chloride raw material into a powder, introducing the pulverized powder and hot air into a sublimator 2. The powder is heated by the hot air to obtain aluminum chloride sublimation gas, wherein the temperature inside the sublimator is maintained 250° C. to 350° C., and the temperature of the hot air is 250° C. to 500° C.;
introducing the aluminum chloride sublimation gas into a cyclone separation mechanism 4 to perform cyclone separation, and to obtain aluminum chloride gas. The temperature inside the cyclone separation mechanism 4 is maintained 200° C. to 300° C.

In the purification process of anhydrous aluminum chloride according to the present disclosure, it was found that by introducing hot air at a specific temperature (250° C. to 500° C.) and industrial anhydrous aluminum chloride powder raw materials into the sublimator 2 at a specific temperature (250° C. to 350° C.), the aluminum chloride in the raw materials is gas-solid separated from ferric chloride under the action of hot air. The aluminum chloride is vaporized and sublimated. During the sublimation process, the hydrated aluminum chloride that absorbs water in the anhydrous aluminum chloride raw materials will be dehydrated to form aluminum oxide particles. In the subsequent cyclone separation process of the cyclone separation mechanism 4, the specific temperature (200° C. to 300° C.) of the cyclone separation mechanism 4 is controlled so that the solid particles will be captured by centrifugal motion in the cyclone, and the sublimated aluminum chloride gas will be collected. It will still maintain a gaseous state to separate from solid particles, thereby achieving purification of anhydrous aluminum chloride raw materials. The solid impurities such as hydrated aluminum chloride that absorbs water and ferric chloride in the raw material anhydrous aluminum chloride can be fully removed. The iron content in the resulting aluminum chloride product can be reduced to below 72 ppm, and the content of water-insoluble substances can be reduced to 0.03%. The application of aluminum chloride in the preparation of alumina can reduce the particulate matter in the finished alumina by 99% on the original basis, and reduce the iron content in the end product from above 400 ppm to below 200 ppm, which well meets the requirements of lithium battery industry.

Preferably, the temperature of the sublimator 2 is between 280° C. to 300° C., and the temperature of the hot air is between 280° C. to 350° C. Controlling the temperature of sublimator 2 and the temperature of the hot air within this preferred range can better achieve gas-solid separation of anhydrous aluminum chloride and ferric chloride, thereby improving the purity of anhydrous aluminum chloride. Further preferred, the temperature of the sublimator 2 is 290° C. to 300° C., and the temperature of the hot air is 300° C. to 320° C.

In some embodiments, the cyclone separation mechanism 4 comprises a first cyclone separator and a second cyclone separator connected in series. The aluminum chloride sublimation gas is passed into the first cyclone separator for cyclone separation at 200° C. to 300° C., and the resulting gas-phase product is passed into the second cyclone separator for cyclone separation at 200° C. to 280° C.

Preferably, the temperature inside the first cyclone separator is 250° C. to 300° C., and the temperature inside the second cyclone separator is 220° C. to 260° C. Further preferred, the temperature inside the first cyclone separator is 260° C. to 280° C., and the temperature inside the second cyclone separator is 240° C. to 250° C.

It can be understood that by setting up the first cyclone separator and the second cyclone separator to form a two-stage cyclone separator in series, and controlling the aluminum chloride sublimation gas to pass through the two cyclone separators in series for cyclone separation, and controlling the temperature of the two cyclone separators within this preferred range, the aluminum chloride gas can be better maintained in a gaseous state and separated from solid particles in the cyclone, thereby effectively removing solid impurities such as hydrated aluminum chloride and ferric chloride.

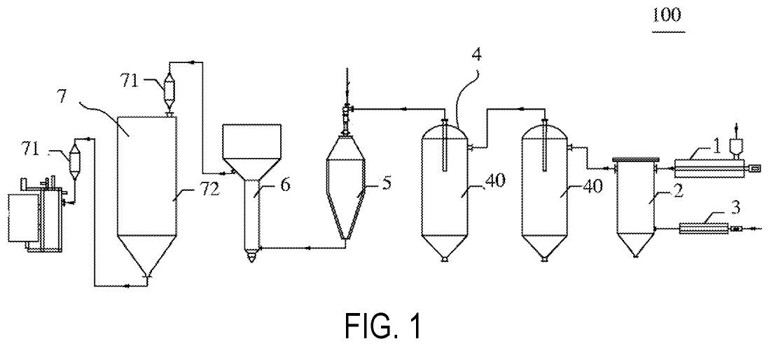

The present disclosure provides a gas-phase nano-alumina preparation device 100, as shown in FIGS. 1 to 3. The gas-phase nano-alumina preparation device 100 comprises a conveying and processing mechanism 1, a sublimator 2, a gas heating mechanism 3, a cyclone separation mechanism 4, a reactor 5, a deacidification furnace 6, and a magnetic iron removal mechanism 7.

The conveying and processing mechanism 1 is used for pulverizeing and conveying aluminum chloride raw materials. The conveying and processing mechanism 1 can be as a screw conveyor, which can pulverize the aluminum chloride raw material and synchronously transport the aluminum chloride powder to the subsequent equipment during the pulverizeing process, where the pulverized aluminum chloride powder is sent into the sublimator 2 for further reaction.

The sublimator 2 has a feed inlet 21, a first air inlet 22, and a first air outlet 23; the conveying and processing mechanism 1 is connected to the feed inlet 21 of the sublimator 2 and used to feed the pulverizeed aluminum chloride powder into the sublimator 2. The gas heating mechanism 3 is connected to the first inlet 22 and used to feed the heated gas into the sublimator 2 to heat up the aluminum chloride powder; among them, the gas heating mechanism 3 heats the gas, such as air, to a specific temperature and sends it into the sublimator 2 through the first inlet 22. The aluminum chloride powder enters the sublimator 2 through the feed inlet 21. Under the action of hot air at a specific temperature, the aluminum chloride can be gas-solid separated from the iron chloride. The aluminum chloride vaporizes and sublimates. During the sublimation process, the hydrated aluminum chloride that absorbs water in the aluminum chloride will dehydrate to form aluminum oxide particles. The aluminum chloride sublimation gas carrying particles is further passed into the next stage of cyclone separation mechanism 4 for cyclone separation.

The cyclone separation mechanism 4 has a second air inlet 42 and a second air outlet 43. The second air inlet 42 is connected to the first air outlet 23, and the second air outlet 43 is sequentially connected to the reactor 5, the deacidification furnace 6, and the magnetic iron removal mechanism 7. The aluminum chloride sublimation gas in the sublimator 2 enters the cyclone separation mechanism 4 through the first air outlet 23 and the second air inlet 42 in sequence. In the cyclone separation mechanism 4, solid particles will be captured by centrifugal motion in the cyclone, and the sublimated aluminum chloride gas will remain in a gas state to separate from the solid particles, thereby achieving the sublimation and purification of the raw material aluminum chloride. The solid impurities such as hydrated aluminum chloride that absorbs water and ferric chloride in the raw material aluminum chloride can be fully removed to obtain aluminum chloride gas;

The obtained aluminum chloride gas is introduced into reactor 5 for reaction to generate nano-alumina; followed with being sent to the deacidification furnace 6 for deacidification; after deacidification, the nano-alumina is sent to the magnetic iron removal mechanism 7 for iron removal, resulting in nano-alumina. The obtained nano-alumina can be sent to the product silo for storage.

In summary, the gas-phase nano-alumina preparation device 100 is equipped with a conveying and processing mechanism 1, a sublimator 2, and a cyclone separation mechanism 4 at the front end of reactor 5, and a deacidification furnace 6 and a magnetic iron removal mechanism 7 at the rear end of reactor 5. Before the aluminum chloride raw material is fed into reactor 5 for reaction, the iron removal and purification operation of the raw material aluminum chloride is first achieved through the cooperation of the conveying and processing mechanism 1, the sublimator 2, and the cyclone separation mechanism 4. After the iron removal and purification, the aluminum chloride gas is sent to the reactor 5 for reaction to obtain nano-alumina products. After deacidification by the deacidification furnace 6, the magnetic iron substances in the nano-alumina end product are captured by adsorption in conjunction with the magnetic iron removal mechanism 7, to remove iron in nano-alumina products. The iron content in nano-alumina products can be reduced to below 150 ppm, which well meets the application requirements in the field of lithium batteries.

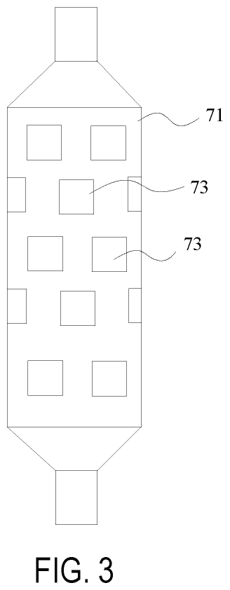

In some embodiments, as shown in FIGS. 1 and 3, the magnetic suction iron removal mechanism 7 comprises at least two sequentially connected magnetic attraction members 71. Specifically, the magnetic suction iron removal mechanism 7 forms a multi-level magnetic suction structure by setting multiple magnetic attraction members 71. Preferably, the magnetic suction iron removal mechanism 7 comprises two magnetic attraction members 71, and the storage silo 72 is arranged between the two magnetic attraction members 71. The two magnetic attraction members 71 are respectively arranged before the nano-alumina end product enters the storage silo 72 and before the nano-alumina end product enters the packaging machine (packaging bag). The magnetic attraction members 71 are tubular structures, and the inner walls of the tubular structures are both provided with magnetic suction layer. The nano-alumina first flows through the tubular structure of the first magnetic attraction member 71. During the flow, the magnetic iron substances in the finished nano-alumina are adsorbed by the magnetic attraction layer for the first separation from the nano-alumina. Then, the nano-alumina after the first separation is sent to the storage silo 72 for buffering, and when it reaches a certain amount, it is sent to the tubular structure of the second magnetic attraction member 71. During the flow, the magnetic iron substances in the finished nano-alumina are adsorbed again by the magnetic attraction layer for the second separation from the nano-alumina. The two magnetic attraction members 71 cooperate to perform two-stage magnetic iron substance separation on the nano-alumina, and then enter the packaging machine for product packaging. After removing impurities through secondary magnetic attraction, magnetic substances such as iron, zinc, and manganese can be effectively removed from the end product, improving the quality of nano-alumina products. It should be noted that in other embodiments, the number of magnetic attraction members 71 is not limited to two, and other numbers such as three, four, five, etc. can be set adaptively. The specific number can be set according to the actual iron removal requirements, and there is no special limitation. In this embodiment, the magnetic iron removal mechanism 7 is equipped with two magnetic attraction members 71, which can simplify the structure and cut costs, and also achieve good iron removal effect.

In some embodiments, as shown in FIG. 3, the magnetic attraction layer comprises multiple magnetic bodies 73, each of which is arranged at intervals along the circumferential and axial directions of the tubular structure, and adjacent magnetic bodies 73 are staggered along the axial direction of the tubular structure. By arranging the magnetic bodies 73 on the inner wall of the tubular structure according to the specific structure, it is possible to evenly distribute magnetism at various positions on the inner wall of the tubular structure, so that the magnetic iron substances flowing through the magnetic attraction members 71 are better adsorbed by the magnetic bodies 73 on the inner wall of the tubular structure, thereby better removing the magnetic iron substances from the end product. In addition, the shape of the magnetic bodies 73 can be square or cylindrical, and can be an electromagnet or a permanent magnet. Furthermore, the magnetic bodies 73 can be detachably installed on the inner wall of the tubular structure for easy removal of foreign objects.

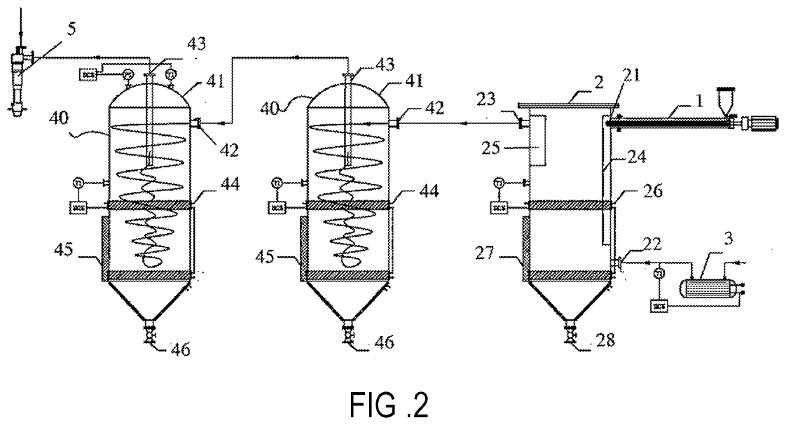

In some embodiments, as shown in FIG. 2, the cyclone separation mechanism 4 comprises two cyclone separators 40 connected in series, which are the first cyclone separator and the second cyclone separator respectively; the first cyclone separator and the second cyclone separator both include a separator body 41, which is provided with a second air inlet 42 and a second air outlet 43. The second air inlet 42 is opened on the side wall of the separator body 41 along the transverse section direction of the separator body 41, and is located below the second air outlet 43.

Wherein, the aim of the first cyclone separator at the top location is to introduce the sublimated aluminum chloride gas into the separator body 41 along the tangential direction through the second air inlet 42. The solid particles carried in the gas separated from the gas phase due to centrifugal effect and adhere to the inner wall of the separator body 41. When a certain amount is reached, they will sink to the bottom of the separator body 41 by gravity. The separated aluminum chloride gas will be introduced into the next stage of the second cyclone separator through the second air outlet 43 for further cyclone separation operation. Two cyclone separators 40 are used in combination to perform two-stage cyclone separation on the sublimated aluminum chloride sublimation gas, which can simplify the structure and cut costs, and also achieve good particle removal effect. Wherein, the top of the second cyclone separator is equipped with pressure and temperature measurement points, which are directly connected to the DCS production control system in real time to monitor the stability of the system.

In some embodiments, as shown in FIG. 2, the outer wall of the separator body 41 is provided with a first heating element 44, and the separator body 41 is located outside the first heating element 44 and provided with a first insulation layer 45. Among them, the first heating element 44 can be a ceramic electric heating plate. The function of the first heating element 44 is to heat and insulate the corresponding cyclone separator 40, preventing the temperature of the inner wall of the cyclone separator 40 from being too low, which could cause aluminum chloride to condense and adsorb on its surface, thereby reducing the sublimation effect of aluminum chloride. The purpose of the first insulation layer 45 is to prevent the heat of the equipment from dissipating to the outside. The bottom of the separator body 41 is equipped with a first slag discharge valve 46, which is used to regularly discharge the solid particles separated from the separator body 41, avoiding affecting the heating and separation effect of the cyclone separator 40.

In some embodiments, as shown in FIG. 2, a guide element 24 is provided inside the sublimator 2, which is arranged between the inlet 21 and the first air inlet 22. The guide element 24 is used to introduce the raw material powder entering from the inlet 21 to the first air inlet 22 to counteract the hot air introduced from the first air inlet 22, thereby increasing the contact degree between the aluminum chloride powder and the hot air, effectively improving the heating efficiency and uniformity of the aluminum chloride powder, and enabling the rapid gasification and effective sublimation of the aluminum chloride in the raw material.

In some embodiments, as shown in FIG. 2, the first air outlet 23 is opened on one side of the sublimator 2, and an air outlet baffle 25 is provided inside the sublimator 2. The air outlet baffle 25 surrounds the inner wall of the sublimator 2 to form a guide chamber with one end open, and the first air outlet 23 is connected to the guide chamber. Wherein, the gas outlet baffle 25 can redirect the sublimated aluminum chloride sublimation gas through the blocking effect of the gas outlet baffle 25 and then flow out through the first gas outlet 23, thereby reducing the solid particles that have not been sublimated from flowing out of the sublimator 2 with the sublimated aluminum chloride sublimation gas.

In some embodiments, as shown in FIG. 2, the outer wall of the sublimator 2 is provided with a second heating element 26, and the sublimator 2 is located outside the second heating element 26 and provided with a second insulation layer 27. Among them, the second heating element 26 can be a ceramic electric heating plate, which is used to heat and maintain the temperature of the sublimator 2, preventing the sublimation effect of aluminum chloride from being reduced due to the low temperature of the sublimator 2. The purpose of the second insulation layer 27 is to keep the heat of the equipment from dissipating to the outside. In addition, a second slag discharge valve 28 is installed at the bottom of the sublimator 2, wherein the purpose of the second slag discharge valve 28 is to regularly discharge the solid particles separated from the sublimator 2, thereby effectively avoiding affecting the heating and separation efficiency of the sublimator 2.

In some embodiments, the reactor 5 can be used to process aluminum chloride to obtain nano-alumina through conventional reactions. Specifically, in this embodiment, the reactor 5 has inlets for hydrogen and air, respectively, and generates nano-alumina primary ions by mixing and burning hydrogen, air, and purified aluminum chloride gas introduced from the cyclone separation mechanism 4. Subsequently, the nano-alumina primary ions further collide and aggregate in the reactor 5 to obtain nano-alumina.

In some embodiments, the deacidification furnace 6 uses electric heating to provide heat to increase the temperature of the deacidification furnace 6, and remove the hydrogen chloride gas adsorbed on the surface of the nano-alumina product at high temperature, thereby increasing the pH value of the product.

In some embodiments, the conveying and processing mechanism 1, the sublimator 2, the gas heating mechanism 3, the cyclone separation mechanism 4, the reactor 5, the deacidification furnace 6, and the magnetic iron removal mechanism 7 of the gas-phase nano-alumina preparation device 100 are all made of corrosion-resistant titanium material.

The embodiments of the present disclosure also provide a method for preparing gas-phase nano-alumina, which comprises the following steps:
pulverizing raw material for the aluminum chloride reaction by a conveying and processing mechanism 1 and then conveying it into a sublimator 2; heating air in a heating mechanism 3, and then conveying the hot air into the sublimator 2; the hot air heats the aluminum chloride powder to produce aluminum chloride sublimation gas;
introducing the aluminum chloride sublimation gas into a cyclone separation mechanism 4 for cyclone separation to obtain aluminum chloride gas;
introducing the obtained aluminum chloride gas into a reactor 5 to react and generate nano-alumina;
introducing the nano-alumina into a deacidification furnace 6 for deacidification;
introducing the deacidified nano-alumina into a magnetic iron removal mechanism 7 for magnetic iron removal, then obtaining nano-alumina.

The following specific examples are used to illustrate the solution of the present disclosure.

### Example 1

The gas-phase nano-alumina preparation device 100 used in this Example is shown in FIG. 1 to FIG. 3 as follows.

A gas-phase nano-alumina preparation device 100, comprised a conveying and processing mechanism 1, a sublimator 2, a gas heating mechanism 3, a cyclone separation mechanism 4, a reactor 5, a deacidification furnace 6, and a magnetic iron removal mechanism 7 connected sequentially.

The conveying and processing mechanism 1 was a screw conveyor, and a material measuring device was installed at the entrance of the screw conveyor.

The sublimation device 2 had a feed inlet 21, a first air inlet 22, and a first air outlet 23. The sublimation device 2 was equipped with a guide element 24, which was located between the feed inlet 21 and the first air inlet 22. The first air outlet 23 was opened on one side of the sublimation device 2, and an air outlet baffle 25 was installed inside the sublimation device 2. The air outlet baffle 25 was surrounded by the inner wall of sublimation device 2 to form an open guide chamber, and the first air outlet 23 was connected to the guide chamber.

The cyclone separation mechanism 4 included two sequentially connected cyclone separators 40, namely a first cyclone separator and a second cyclone separator. Both the first and second cyclone separators included a separator body 41, which was provided with a second air inlet 42 and a second air outlet 43. The second air inlet 42 was installed on the side wall of the separator body 41 along the transverse cross-section direction of the separator body 41, and the second air inlet 42 was located below the second air outlet 43.

The magnetic iron removal mechanism 7 included two sequentially connected magnetic attraction members 71, and a storage silo 72 was provided between adjacent magnetic attraction members 71.

### Example 2

This Example provided a purification method for anhydrous aluminum chloride, using the device shown in Example 1.

The purification method of anhydrous aluminum chloride included the following steps.

The first-class anhydrous aluminum chloride was used. The temperature inside sublimator 2 was controlled at 300° C.; the hot air temperature was 320° C.; the temperature of the first cyclone separator was 260° C., and the temperature of the second cyclone separator was 240° C. The aluminum chloride gas from the first and second cyclone separators was collected and tested for iron content and water-insoluble substances according to the national standard “Industrial Anhydrous Aluminum Chloride” (GB/T 9592008). The results were shown in Table 1.

TABLE 1
Test results of iron content and water-insoluble
matter of aluminum chloride gas in Example 2

| | First-grade | Primary cyclone | Secondary cyclone |
|---|---|---|---|
| | raw | separation of raw | separation of raw |
| Test metrics | materials | materials | materials |
| Iron content (ppm) | 165.5 | 82.3 | 52.6 |
| Water-insoluble | 0.08 | 0.05 | 0.03 |
| substance (%) | | | |

### Example 3

The difference between this Example and Example 2 is stated below.

Using superior-quality anhydrous aluminum chloride, the temperature inside sublimator 2 was controlled at 300° C.; the hot air temperature was 300° C.; the temperature of the first cyclone separator was 280° C., and the temperature of the second cyclone separator was 250° C. The aluminum chloride gas from the first and second cyclone separators was collected and tested for iron content and water-insoluble substances. The results were shown in Table 2.

TABLE 2
Test results of iron content and water-insoluble
matter of aluminum chloride gas in Example 3

| | Superior- | Primary cyclone | Secondary cyclone |
|---|---|---|---|
| | quality | separation of raw | separation of raw |
| Test metrics | raw materials | materials | materials |
| Iron content (ppm) | 134.3 | 70.1 | 31.3 |
| Water-insoluble | 0.04 | 0.03 | 0.01 |
| substance (%) | | | |

### Example 4

The difference between this Example and Example 2 is stated below.

The temperature inside sublimator 2 was controlled at 350° C., and the temperature of the hot air was controlled at 350° C.

The aluminum chloride gas was collected and tested for iron content and water-insoluble substances. The results were shown in Table 3.

TABLE 3
Test results of iron content and water-insoluble
matter of aluminum chloride gas in Example 4

| | First-grade | Primary cyclone | Secondary cyclone |
|---|---|---|---|
| | raw | separation of raw | separation of raw |
| Test metrics | materials | materials | materials |
| Iron content (ppm) | 166.2 | 101.3 | 63.2 |
| Water-insoluble | 0.08 | 0.05 | 0.03 |
| substance (%) | | | |

### Example 5

The difference between this Example and Example 2 is that:

The temperature of the first cyclone separator was controlled at 300° C., and the temperature of the second cyclone separator was 300° C. The aluminum chloride gas from the first and second cyclone separators was collected and tested for iron content and water-insoluble substances. The results were shown in Table 4.

TABLE 4
Test results of iron content and water-insoluble
matter of aluminum chloride gas in Example 5

| | First-grade | Primary cyclone | Secondary cyclone |
|---|---|---|---|
| | raw | separation of raw | separation of raw |
| Test metrics | materials | materials | materials |
| Iron content (ppm) | 168.4 | 85.2 | 71.2 |
| Water-insoluble | 0.10 | 0.06 | 0.03 |
| substance (%) | | | |

### Contrastive Example 1

The difference between this contrastive Example and Example 2 is stated below.

The temperature inside sublimator 2 was controlled at 400° C., and the temperature of the hot air was controlled at 600° C.

The aluminum chloride gas was collected and tested for iron content and water-insoluble substances. The results were shown in Table 5.

TABLE 5
Test results of iron content and water-insoluble matter
of aluminum chloride gas in Contrastive Example 1

| | First-grade | Primary cyclone | Secondary cyclone |
|---|---|---|---|
| | raw | separation of raw | separation of raw |
| Test metrics | materials | materials | materials |
| Iron content (ppm) | 158.4 | 137.2 | 86.1 |
| Water-insoluble | 0.08 | 0.06 | 0.05 |
| substance (%) | | | |

### Contrastive Example 2

The difference between this contrastive Example and Example 2 is stated below.

The temperature of the first cyclone separator was controlled at 350° C., and the temperature of the second cyclone separator was 350° C.

The aluminum chloride gas was collected and tested for iron content and water-insoluble substances. The results were shown in Table 6.

TABLE 6
Test results of iron content and water-insoluble matter
of aluminum chloride gas in Contrastive Example 2

| | First-grade | Primary cyclone | Secondary cyclone |
|---|---|---|---|
| | raw | separation of raw | separation of raw |
| Test metrics | materials | materials | materials |
| Iron content (ppm) | 163.7 | 87.5 | 78.2 |
| Water-insoluble | 0.10 | 0.06 | 0.04 |
| substance (%) | | | |

From the results presented in Tables 1 to 6, it can be observed that the purity of aluminum chloride obtained in Example 2 and Example 3 were the highest. The iron content in the finished aluminum chloride products decreased by 112.9 ppm and 103 ppm, respectively, resulting in iron contents as low as 52.6 ppm and 31.3 ppm in the final products. Additionally, the content of water-insoluble substance decreased by 0.05% and 0.03%, respectively, with the final content of water-insoluble substance reaching 0.03% and 0.01% in the respective products.

In Example 4, compared to Example 2, the temperature of the sublimator 2 was increased to 350° C., and the temperature of the hot air was increased to 350° C. It was observed that the iron content of the raw material entering the primary cyclone separator increased, but after passing through the second cyclone separator, most of the iron and water-insoluble substances were removed.

In Example 5, compared to Example 2, the temperature of the first and second cyclone separators were increased to 300° C., and it was also found that the removal efficiency of iron and water-insoluble substances decreased.

In Comparative Example 1, compared to Example 2, the temperature of the sublimator 2 was increased to 400° C. and the temperature of the hot air was increased to 600° C., it was observed that the removal efficiency of iron and water-insoluble substances decreased, especially in the primary separation, where the impurity removal efficiency was very low.

In Comparative Example 2, compared to Example 2, the temperature of the first cyclone separator was increased to 350° C., and the temperature of the second cyclone separator was also increased to 350° C. It was found that the removal efficiency of iron and water-insolubles significantly decreased.

### Example 6

This Example provided a method for preparing nano-alumina by gas-phase method, using the device shown in Example 1, including the following steps:

Anhydrous aluminum chloride (with FeCl₃ 143.8 ppm) was added to the silo, quantitatively pulverized and transported by a screw conveyor, and introduced into the sublimator 2 along the guide element 24. Under the action of hot air input from the first inlet 22, anhydrous aluminum chloride was transformed into aluminum chloride gas, which was then discharged from the first air outlet 23 and sequentially enters the first and second cyclone separators. After cyclone separation, hydrolyzed aluminum chloride and some non-gasified impurities settled at the bottom of the cyclone separator. Aluminum chloride gas was discharged from the top and entered reactor 5, where it was mixed with hydrogen and oxygen gas and burned. According to conventional reactions, high-temperature hydrolysis and condensation reactions occurred to obtain aluminum oxide and hydrogen chloride (4AlCl₃+6H₂+3O₂=2Al₂O₃+12HCI). After aggregation, the aluminum oxide generated by the reaction was introduced in the deacidification furnace 6, where hydrogen chloride adsorbed on the surface of the aluminum oxide was removed under conventional high-temperature treatment. After deacidification, the alumina was transported to storage silo 72 through pipelines. Before entering the storage silo 72, the magnetic iron removal mechanism 7 was used for primary impurity removal, capturing various magnetic substances. When the material in storage silo 72 reached a certain amount, product packaging was carried out. Before the material enters the packaging bag, it underwent secondary impurity removal by magnetic suction iron removal mechanism 7, and then the end product was packaged.

Wherein, the temperature inside the sublimator 2 was controlled at 300° C.; the temperature of the hot air was 320° C.; the temperature of the first stage cyclone separator was 260° C., and the temperature of the second stage cyclone separator was 240° C.

The iron content of the prepared nano-alumina end product was determined according to GB/T24264-2020. The 325 μm sieve residue was determined according to GB/T20020-2013, and the magnetic substance was determined by ICP after magnetic sample absorption. The results were shown in Table 7 below:

TABLE 7
Content of iron and magnetic substance in nano-alumina products

| | Content of iron | Content of | | | | | | |
|---|---|---|---|---|---|---|---|---|
| | in the raw | iron in the | Sieve | | | | | |
| | materials | end product | residue | Content of magnetic substance (ppm) | | | | |
| Project | (ppm) | (ppm) | (%) | Cr | Fe | Mn | Ni | Zn |
| Contrastive | 143.8 | 428.7 | 0.201 | 0.0100 | 0.4130 | 0.0040 | 0.0150 | 0.0195 |
| Example | | | | | | | | |
| Example 1 | 134.3 | 93.6 | 0.019 | 0.0048 | 0.0797 | 0.0032 | −0.0050 | 0.0188 |

Note: (1) In Contrastive Example, during the preparation process of alumina, the vaporized aluminum chloride raw material was directly introduced into the reaction furnace for reaction, and the end product did not undergo the magnetic adsorption impurity removal process. (2) The content of Ni was negative because it was below the detection limit of the instrument.

From the above, it can be seen that in Example 6, before the aluminum chloride raw material was fed into the reactor 5, it was first transported to the sublimator 2 and heated until the aluminum chloride in the raw material underwent gas-solid separation from ferric chloride under the action of hot air. The aluminum chloride was vaporized and sublimated. Subsequently, through the cyclone separation in the cyclone separation mechanism 4, solid particles underwent centrifugal motion in the cyclone and was captured, while the sublimated aluminum chloride gas remained in a gaseous state and was separated from the solid particles, thus achieving the iron removal and purification operation of the raw material aluminum chloride. The nano-alumina product was further processed using a magnetic iron removal mechanism 7. The two-stage magnetic separation process enables the capture of magnetic iron-containing impurities present in the final nano-alumina product through adsorption, thereby reducing the iron content in the nano-alumina product to 93.6 ppm, which was much lower than the iron content of 428.7 ppm in the finished product of the Contrastive Example.

The embodiments above merely express several implementations of the present disclosure. The descriptions of the embodiments are relatively specific and detailed, but may not therefore be construed as the limitation on the patent scope of the present disclosure. It should be noted that a person of ordinary skill in the art may further make several variations and improvements without departing from the concept of the present disclosure. These variations and improvements all fall within the protection scope of the present disclosure. Therefore, the patent protection scope of the present disclosure shall be defined by the appended claims.

### REFERENCE SIGNS LIST

100. Nano-alumina preparation device through gas-phase method; 1. Conveying and processing mechanism; 2. Sublimator; 21. Feed inlet; 22. First air inlet; 23. First air outlet; 24. Guide element; 25. Air outlet baffle; 26. Second heating element; 27. Second insulation layer; 28. Second slag discharge valve; 3. Gas heating mechanism; 4. Cyclone separation mechanism; 40. Cyclone separator; 41. Separator body; 42. Second air inlet; 43. Second air outlet; 44. First heating element; 45. First insulation layer; 46. First slag discharge valve; 5. Reactor; 6. Deacidification furnace; 7. Magnetic iron removal mechanism; 71. Magnetic attraction piece; 72. Storage silo; 73. Magnetic body.

What is claimed is:

1. A purification method for anhydrous aluminum chloride, comprising the following steps:
pulverizing anhydrous aluminum chloride raw material into a powder, introducing the pulverized powder and hot air into a sublimator, such that the powder is heated by the hot air to obtain aluminum chloride sublimation gas, wherein the temperature inside the sublimator is maintained 250° C. to 350° C., and the temperature of the hot air is 250° C. to 500° C.; and
introducing the aluminum chloride sublimation gas into a cyclone separation mechanism to perform cyclone separation, to obtain aluminum chloride gas, the temperature inside the cyclone separation mechanism is maintained 200° C. to 300° C.

2. The purification method for anhydrous aluminum chloride according to claim 1, wherein the temperature inside the sublimator is 280° C. to 300° C., and the temperature of the hot air is 280° C. to 350° C.

3. The purification method for anhydrous aluminum chloride according to claim 1, wherein the temperature inside the sublimator is 290° C. to 300° C., and the temperature of the hot air is 300° C. to 320° C.

4. The purification method for anhydrous aluminum chloride according to claim 1, wherein the cyclone separation mechanism comprises a first cyclone separator and a second cyclone separator connected in series, the aluminum chloride sublimation gas is introduced into the first cyclone separator for cyclone separation at 200° C. to 300° C., and the obtained gas-phase product is subsequently introduced into the second cyclone separator for cyclone separation at 200° C. to 280° C.

5. The purification method for anhydrous aluminum chloride according to claim 4, wherein the temperature inside the first cyclone separator is 250° C. to 300° C., and the temperature inside the second cyclone separator is 220° C. to 260° C.

6. The purification method for anhydrous aluminum chloride according to claim 5, wherein the temperature inside the first cyclone separator is 260° C. to 280° C., and the temperature inside the second cyclone separator is 240° C. to 250° C.

7. A gas-phase nano-alumina preparation device, comprising a conveying and processing mechanism, a sublimator, a gas heating mechanism, a cyclone separation mechanism, a reactor, a deacidification furnace, and a magnetic iron removal mechanism;
wherein, the conveying and processing mechanism is configured to pulverize and convey aluminum chloride raw material;
the sublimator has a feed inlet, a first air inlet, and a first air outlet; the conveying and processing mechanism is connected to the feed inlet of the sublimator and is configured to introduce the pulverized aluminum chloride powder into the sublimator, while the gas heating mechanism is connected to the first air inlet and is configured to introduce the heated gas into the sublimator to heat the aluminum chloride powder;
the cyclone separation mechanism has a second air inlet and a second air outlet, wherein the second air inlet is connected to the first air outlet, and the second air outlet is sequentially connected to the reactor, the deacidification furnace, and the magnetic iron removal mechanism.

8. The gas-phase nano-alumina preparation device according to claim 7, wherein the magnetic iron removal mechanism comprises at least two sequentially connected magnetic attraction members, and the deacidified nano-alumina sequentially enters the magnetic attraction members, and a storage silo is set between adjacent two magnetic attraction members, wherein each magnetic attraction member features a tubular structure, and the inner walls of the tubular structures are coated with magnetic attraction layer.

9. The gas-phase nano-alumina preparation device according to claim 8, wherein the magnetic attraction layer comprises multiple magnetic bodies, which are spaced apart along the circumferential and axial direction of the tubular structure, and adjacent magnetic bodies are staggered along the axial direction of the tubular structure.

10. The gas-phase nano-alumina preparation device according to claim 8, wherein the magnetic iron removal mechanism comprises two magnetic attraction members, which cooperate to form a two-stage magnetic attraction structure.

11. The gas-phase nano-alumina preparation device according to claim 7, wherein the cyclone separation mechanism comprises two cyclone separators connected in series, which are a first cyclone separator and a second cyclone separator, respectively,
wherein both the first cyclone separator and the second cyclone separator include a separator body, which is provided with a second air inlet and a second air outlet, wherein the second air inlet is provided on the side wall of the separator body along the transverse section direction of the separator body, and the second air inlet is located below the second air outlet.

12. The gas-phase nano-alumina preparation device according to claim 11, wherein the outer wall of the separator body is provided with a first heating element, and the separator body is located on the outer side of the first heating element and is provided with a first thermal insulation layer.

13. The gas-phase nano-alumina preparation device according to claim 7, wherein a guide element is provided inside the sublimator, and the guide element is arranged between the feed inlet and the first air inlet; and serves to guide the raw material powder entering from the feed inlet to the first air inlet, enabling the raw material powder to counter-flow against the hot air entering from the first air inlet.

14. The gas-phase nano-alumina preparation device according to claim 7, wherein the outer wall of the sublimator is equipped with a second heating element, and the sublimator is located on the outer side of the second heating element and is provided with a second thermal insulation layer.

15. The gas-phase nano-alumina preparation device according to claim 7, wherein the first air outlet is located on one side of the sublimator, and an air outlet baffle is installed inside the sublimator; the air outlet baffle and the inner wall of the sublimator collectively form a guide chamber with one end open, and the first air outlet is connected to the guide chamber.

16. A preparation method for gas-phase nano-alumina, comprising the following steps:
pulverizing raw material for the aluminum chloride reaction by a conveying and processing mechanism and then conveying into a sublimator; heating air in a heating mechanism, and then conveying the hot air into the sublimator; the hot air heats the aluminum chloride powder to produce aluminum chloride sublimation gas, the temperature inside the sublimator is maintained 250° C. to 350° C., and the temperature of the hot air is 250° C. to 500° C.;
introducing the aluminum chloride sublimation gas into a cyclone separation mechanism for cyclone separation to obtain aluminum chloride gas, the temperature inside the cyclone separation mechanism is maintained 200° C. to 300° C.;
introducing the obtained aluminum chloride gas into a reactor to react and generate nano-alumina;
introducing the nano-alumina into a deacidification furnace for deacidification; and
introducing the deacidified nano-alumina into a magnetic iron removal mechanism for magnetic iron removal, then obtaining nano-alumina.
